(19) United States
(12) Patent Application Publication
(10) Pub. No.: US 2005/0204539 A1
(43) Pub. Date: Sep. 22, 2005

(54) Method of assembling a fluid dispenser

(75) Inventor: Olivier De Pous, Paris (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S

(21) Appl. No.: 10/886,605

(22) Filed: Jul. 9, 2004

(30) Foreign Application Priority Data
Jul. 10, 2003 (FR) FR-03/08488

(51) Int. Cl. B23P 19/02; B23P 19/00

(52) U.S. Cl. 29/525; 29/801; 29/428

(57) ABSTRACT

The present invention relates to a method of assembling a fluid dispenser comprising: a reservoir (1) defining an opening (140) giving access to a reservoir body (10) designed to contain fluid; a dispenser member (3); and a fixing member (2) comprising fixing means (21) co-operating with the opening of the reservoir, and a reception housing (23, 213) in which the dispenser member is received in such a manner as to mount the dispenser member on the opening of the reservoir, the fixing member including a fixing skirt (21), the skirt (21) comprising a free bottom end. The method successively comprises a first step of permanently mounting the fixing member on the opening by fixing the skirt (21) in leaktight manner in the opening (14), and a second step of mounting the dispenser member on the fixing member, the dispenser member coming into contact with the free bottom end of the skirt.

The present invention relates to a method of assembling a fluid dispenser of the type comprising: a reservoir defining an opening giving access to a reservoir body designed to contain fluid; a dispenser member; and a fixing member comprising fixing means co-operating with the opening of the reservoir, and reception means in which the dispenser member is received in such a manner as to mount the dispenser member on the opening of the reservoir. This type of dispenser is often used in the fields of perfumery, cosmetics, or even pharmacy in order to dispense fluids or even powders.

In general, the dispenser member, which is in the form of a pump or a valve, is firstly mounted or pre-mounted in the fixing member which is often in the form of a ring. Then, the assembly constituted by the dispenser member already mounted or pre-mounted on the fixing member is mounted in or on the opening defined by the reservoir. Naturally, before mounting the assembly constituted by the dispenser member and the fixing member on the reservoir, it is necessary to fill said reservoir with fluid. The dispenser member and fixing member assembly provides a stopper function while also enabling the fluid to be dispensed.

An object of the present invention is to define another assembly sequence which enables the dispenser reservoir to be filled more conveniently, while simultaneously providing improved fixing of the fixing member on the reservoir.

In order to achieve these objects, the method of the present invention successively comprises a first step of permanently mounting the fixing member on the opening, and a second step of mounting the dispenser member on the fixing member.

In other words, the fixing member is mounted on the reservoir before the dispenser member is mounted on the fixing member. The reservoir and the fixing member thus constitute a first already-assembled sub-assembly, still enabling the reservoir to be filled with fluid through the fixing member. The dispenser member can then be mounted on the fixing member.

According to a characteristic of a dispenser for assembly by the method, the fixing member includes a fixing skirt in fixed engagement in the opening, and a bearing collar that bears on an edge of the opening.

According to another characteristic, the skirt includes a contact zone designed to come into contact with the dispenser member.

The skirt advantageously includes a free bottom end, said contact zone being formed at said bottom end.

In another aspect, the fixing member includes a reception sleeve designed to hold the dispenser member by leaktight radial clamping.

The sleeve advantageously extends above the bearing collar.

In another embodiment, the reservoir includes a projecting neck forming the opening, said neck including an inside wall forming a recess, the fixing member forming a skirt that is inserted into the neck in such a manner as to penetrate into said recess.

In addition, the dispenser member may include a stepped body forming a section of larger outside diameter and a section of smaller outside diameter, and a radial flange situated above the larger-diameter section, the flange coming into abutment contact against the fixing member, the larger- and smaller-diameter sections becoming radially clamped in the fixing member.

In the invention, it is preferable for the first mounting step to take place several hours, and preferably several days, before the second mounting step so as to enable the fixing member to creep into contact with the opening.

Naturally, in order to enable the fixing member to creep well in the opening, it is preferable for the reservoir to be made of a material that is harder than the fixing member. Preferably, the reservoir is made of glass and the fixing member is made of plastics material.

The invention is described more fully below with reference to the accompanying drawings which show an embodiment of the invention by way of non-limiting example.

In the figures:

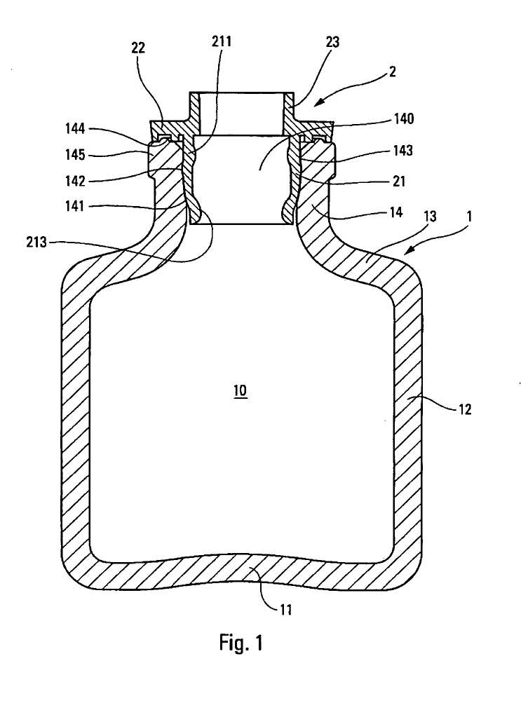

FIG. 1 is a vertical section through an assembly constituted by a reservoir and by a fixing member already pre-mounted on the reservoir in accordance with the invention;

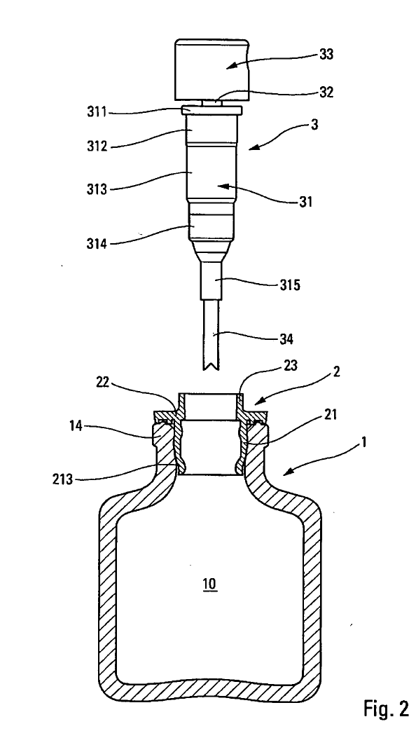

FIG. 2 is an exploded view of a dispenser showing the dispenser member ready to be mounted on the FIG. 1 assembly; and

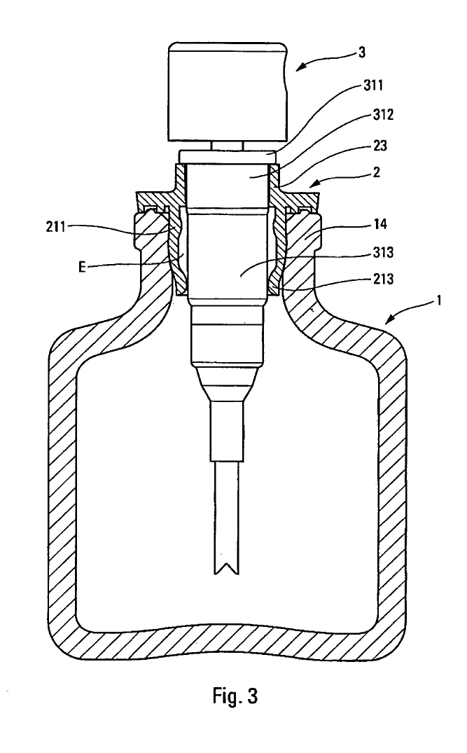

FIG. 3 is a vertical section view through an assembled fluid dispenser of the invention.

The assembly method of the invention is suitable for being implemented on a fluid dispenser comprising three component elements, namely a fluid reservoir 1, a fixing member 2, and a dispenser member 3.

The reservoir 1 comprises a reservoir body 10 formed by a bottom wall 11, side walls 12, and a top shoulder 13.

The reservoir body 10 is designed to contain fluid. Furthermore, the reservoir 1 forms a neck 14 which extends upwards from the shoulder 13. The neck 14 defines an opening 140 which puts the inside of the reservoir body 10 into communication with the outside. The neck 14 includes an inside wall 141 having a peripheral recess 142 formed therein. The recess 142 can extend in continuous manner around the entire periphery of the inside wall 141, or in a variant, the recess 142 can extend around the periphery of the inside wall 141 in the form of discontinuous sectors or segments. The recess 142 defines a maximum-diameter section of the inside wall 141. Below the recess 142, the inside wall 141 presents a smaller diameter. The recess 142 is surmounted in symmetrical manner by a narrow opening section 143 presenting an inside diameter that is smaller than the diameter of the recess. This portion of narrow opening section 143 is extended upwards by an inlet chamfer. Beyond said chamfer, the neck forms an annular top edge 144 which can possibly be formed with a sealing ring. The neck 14 also forms an external peripheral reinforcement 145 which projects outwards.

Such a design is entirely conventional for a fluid reservoir made of glass. However, the reservoir can be made with other materials, such as plastics materials, or even metal. The reservoir 1 can also be made without forming a projecting neck 14, so that the opening 140 is provided directly at or by the shoulder 13. The opening can also be in the form of a simple hole in a wall.

The fixing member 2 is in the form of a ring that is circularly-cylindrical about an axis of symmetry. The fixing member 2 can be made of plastics material. The fixing member includes a fixing skirt 21 which extends downwards from a peripheral collar 22 which extends radially outwards. The fixing member 2 also includes a holding sleeve 23 which extends upwards from the collar 22. The top end of the skirt is thus connected directly to the sleeve, thereby forming a shoulder: the inside diameter of the sleeve is less than the inside diameter of the top end of the skirt. The fixing skirt 21 is inserted into the neck 14 so that the outside wall of the skirt 21 comes into clamping contact with the inside wall 141 of the neck 14. Advantageously, the skirt 21 is elastically deformable so as to take up the shape of the profile of the inside wall 141 of the neck 14, which forms a recess 142 and a narrow opening section 145, as described above. As can be seen in FIG. 1, the skirt 21 is deformed, particularly at the narrow opening section 143: the deformation of the skirt 21 creating a bulge 211 which projects radially inwards. Below said bulge 211, the skirt 21 penetrates into the recess 142 taking up the shape of the wall 141. The free end 213 of the skirt 21 can be separate from the wall 141. It is explained below that the inside portion of the bottom end 213 forms a contact zone designed to come to bear against the dispenser member. In addition, the holding sleeve 23 preferably presents an inside wall that is perfectly or substantially circularly-cylindrical. However, one or more sealing rings can be provided at the inside wall of the holding sleeve 23. The final assembly position of the fixing ring 2 on the neck 14 is achieved when the peripheral collar 22 comes to bear on the edge 144 of the neck 14. This is shown in FIG. 1.

The dispenser member 3, which can be a pump or a valve, includes a body 31 inside which there is mounted an actuator rod 32 which can be displaced axially up and down. The actuator rod 32 is surmounted by a dispenser head 33 which can advantageously integrate a dispenser orifice in the form of a spray nozzle. From bottom to top, the body 31 comprises a connection sleeve 315 which can be fitted with a dip-tube 34. Above the sleeve 315, the body forms a plurality of sections of various outside diameters. In order of increasing diameter, the body forms a section 314, a section 313, and a section 312. The section 312 is the section with the maximum outside diameter, and the section 313 presents a section of smaller outside diameter. With regard to section 314, it presents a minimum outside diameter. The body 31 also forms a top radial flange 311 which presents an outside diameter that is even greater than the section 312. Once again, this is a configuration that is entirely conventional for a pump or a valve. The flange 311 is situated above the section 312.

According to the invention, the fixing member 2 is initially mounted in its final mounting position on the reservoir 1, as shown in FIG. 1. The fixing member 2 and the reservoir 1 thus form an assembly that is pre-mounted in permanent manner. It should be noted that the reservoir 1 can be filled through the fixing member which leaves the opening 140 of the neck 14 open. Once the reservoir has been filled, the dispenser member is then mounted on its own on or in the fixing member 2. In the final mounted position, the top section 312 comes into leaktight radial clamping contact in the holding sleeve 23. In addition, the section 313 comes into leaktight or non-leaktight bearing contact with the free bottom end 213 which forms a bearing zone. Between the sleeve 23 and the contact zone 213 there exists a dividing or intermediate space E between the skirt 21 and the body 31 of the dispenser member. The space E enables the skirt to deform freely when coming into contact with the body. The depth to which the body 31 penetrates into the fixing member 2 is limited by the radial flange 311 which comes into abutment on the top end of the sleeve 23.

The prior final mounting of the fixing member 2 on the reservoir 1 enables the plastics material making up the fixing member 2 to creep so as to take up the shape of the profile of the inside wall 141 of the neck 14. In this way, a better quality fixing is obtained of the fixing member 2 on the reservoir 1. The fixing member 2 is preferably pre-mounted long before the dispenser member 3 is mounted in the fixing member 2. In practice, the reservoir manufacturer can mount the fixing members 2 directly onto their respective reservoirs, and deliver them fitted with fixing members. The packer, e.g. the manufacturer of perfume, cosmetics, or pharmaceuticals, then fills the reservoirs already pre-fitted with their fixing members, then mounts the dispenser members on the fixing members. Between mounting the fixing member on the reservoir and mounting the dispenser member on the fixing member, a relatively long period of time generally elapses, which can be days, weeks, or even months. This extended period enables the material making up the fixing member to creep in complete and permanent manner into contact with the reservoir. This is not the case when the fixing member 2 is pre-mounted with the dispenser member.

By means of the invention, the method of assembly is made easier while increasing the quality of fixing between the component elements of a fluid dispenser.

1. A method of assembling a fluid dispenser comprising:
a reservoir (1) defining an opening (140) giving access to a reservoir body (10) designed to contain fluid;
a dispenser member (3); and
a fixing member (2) comprising fixing means (21) co-operating with the opening of the reservoir, and reception means (23, 213) in which the dispenser member is received in such a manner as to mount the dispenser member on the opening of the reservoir, the fixing member including a fixing skirt (21), the skirt (21) including a free bottom end,
the method being characterized in that it successively comprises:
a first step of permanently mounting the fixing member on the opening by fixing the skirt (21) in leaktight manner in the opening (14); and
a second step of mounting the dispenser member on the fixing member, the dispenser member coming into contact with the free bottom end of the skirt.

2. An assembly method according to claim 1, in which the fixing member includes a bearing collar (22) that bears on an edge (144) of the opening.

3. An assembly method according to claim 1, in which the skirt (21) is not in contact with the dispenser member except at the free bottom end of the skirt.

4. An assembly method according to claim 1, in which the fixing member includes a reception sleeve (23) designed to hold the dispenser member by leaktight radial clamping.

5. An assembly method according to claim 2, in which the sleeve (23) extends above the bearing collar (22).

6. An assembly method according to claim 1, in which the reservoir (1) includes a projecting neck (14) forming the opening (140), said neck including an inside wall (141) forming a recess (142), the skirt (21) being inserted into the neck in such a manner as to penetrate into said recess.

7. An assembly method according to claim 1, in which the dispenser member (3) includes a stepped body (31) forming a section of larger outside diameter (312) and a section of smaller outside diameter (313), and a radial flange (311) situated above the larger-diameter section, the flange coming into abutment contact against the fixing member (2), the larger- and smaller-diameter sections becoming radially clamped in the fixing member.

8. An assembly method according to claim 1, in which the reservoir is made of glass and the fixing member is made of plastics material.

9. An assembly method according to claim 4, in which the skirt includes a top end which is connected to the sleeve, thereby forming a shoulder.

10. A method of assembling a fluid dispenser comprising:
a reservoir (1) defining an opening (140) giving access to a reservoir body (10) designed to contain fluid;
a dispenser member (3); and
a fixing member (2) comprising fixing means (21) co-operating with the opening of the reservoir, and reception means (23, 213) in which the dispenser member is received in such a manner as to mount the dispenser member on the opening of the reservoir, the fixing member including a fixing skirt (21) in fixed engagement in the opening (140), and a bearing collar (22) that bears on an edge (144) of the opening, the fixing member including a reception sleeve (23) designed to hold the dispenser member by leaktight radial clamping,
the method being characterized in that it successively comprises:
a first step of permanently mounting the fixing member on the opening; and
a second step of mounting the dispenser member on the fixing member.

11. An assembly method according to claim 10, in which the sleeve (23) extends above the bearing collar (22).

12. An assembly method according to claim 10, in which the skirt (21) is not in contact with the dispenser member except at the free bottom end of the skirt.

13. An assembly method according to claim 10, in which the dispenser member is in contact with the fixing member only at the sleeve and at the free bottom end of the skirt.

14. An assembly method according to claim 10, in which the dispenser member (3) includes a stepped body (31) forming a section of larger outside diameter (312) and a section of smaller outside diameter (313), and a radial flange (311) situated above the larger-diameter section, the flange coming into abutment contact against the fixing member (2), the larger-diameter section becoming radially clamped in leaktight manner in the sleeve, and the smaller-diameter section becoming radially clamped in the free bottom end of the skirt.
